(19) United States
(12) Patent Application Publication
(10) Pub. No.: US 2024/0220023 A1
(43) Pub. Date: Jul. 4, 2024

(54) TAP TO TOGGLE LOCKS

(71) Applicant: Rivian IP Holdings, LLC, Plymouth, MI (US)

(72) Inventors: Aakash Mali, Daly City, CA (US); Kyle Royston Lobo, Westchester, CA (US); Alexandra Lambertson, Lake Orion, MI (US); Michael Alexander Sierra, Redwood City, CA (US); Erik Robert Glaser, San Mateo, CA (US); Andrea Marie Best, Mountain View, CA (US)

(21) Appl. No.: 18/124,815

(22) Filed: Mar. 22, 2023

Related U.S. Application Data
(60) Provisional application No. 63/436,518, filed on Dec. 31, 2022.

(51) Int. Cl. G06F 3/01; B60R 25/01; B60R 25/20; B60R 25/24; B60R 25/31

(52) U.S. Cl. CPC G06F 3/017; B60R 25/01; B60R 25/2045; B60R 25/24; B60R 25/31

(57) ABSTRACT

Methods and systems are provided for performing vehicle actions in response to detected gesture inputs. The presence of a user proximate to a vehicle is identified and a gesture input is detected based on a sensor signal such as an accelerometer signal. In response to detecting the gesture input, a vehicle action is performed.

### CROSS-REFERENCE TO RELATED APPLICATIONS

This application claims priority to U.S. Provisional Patent Application No. 63/436,518, filed on Dec. 31, 2022, the entire contents of which are hereby expressly incorporated by reference in their entirety.

### INTRODUCTION

The present disclosure is directed to performing vehicle actions.

### SUMMARY

Vehicles are provided with a multiplicity of vehicle actions related to the different functions and capabilities of the vehicle. While different buttons may be provided for performing different vehicle actions, this can introduce complexity. In accordance with the present disclosure, gesture inputs from a user are used to provide a quick and easy way for the user to access vehicle actions that the user may be interested in, such as locking or unlocking a door of the vehicle. In accordance with some embodiments, methods and system are provided for performing a vehicle action in response to detecting a gesture input.

In some embodiments, a presence of a user proximate to a vehicle is identified (e.g., via processing circuitry). For example, the presence of the user can be identified by detecting a short-range wireless signal of a user device (e.g., an ultra-wideband signal or a Bluetooth signal).

In some embodiments, the gesture input is detected based on an accelerometer signal. For example, an accelerometer located on or within a door handle or door of a vehicle may generate the accelerometer signal. As one example, the gesture input may correspond to two knocks, within a period of time, on the door of the vehicle.

In some embodiments, in response to detecting the gesture input, a vehicle action is performed. For example, in response to detecting two knocks within a period of time on a door of the vehicle, the vehicle action may comprise locking or unlocking the door.

In some embodiments, the gesture input may be one of a plurality of different detectable gesture inputs, and each one of the plurality of different detectable gesture inputs corresponds to a different vehicle action. The different vehicle actions may comprise locking or unlocking a single door, locking or unlocking all of the doors, opening or closing windows, opening or closing vehicle enclosures, activating or deactivating a guard mode, activating or deactivating alarm monitoring, or triggering an alarm, or a combination thereof.

In some embodiments, a noise filter may be used to filter the accelerometer signal to attenuate noise from vehicle movement.

In accordance with some embodiments of the present disclosure, a vehicle is provided with an accelerometer configured to generate an accelerometer signal and processing circuitry. In some embodiments, the accelerometer may be located on a door handle of the vehicle. In some embodiments, the processing circuitry is configured to identify a presence of a user proximate to the vehicle. For example, the vehicle may further comprise a transceiver configured to receive a short-range wireless signal of a user device and the processing circuitry is configured to identify the presence of the user based on a received short-range wireless signal. In some embodiments, the processing circuitry is configured to detect, based on the accelerometer signal, a gesture input, and to cause a vehicle action to be performed in response to detecting the gesture input. For example, the gesture input may comprise two knocks within a period of time on a door of the vehicle, and the vehicle action may comprise locking or unlocking the door. As another example, the gesture input may be one of a plurality of different detectable gesture inputs, and each one of the plurality of different detectable gesture inputs may correspond to a vehicle action. The vehicle action may comprise locking or unlocking a single door, locking or unlocking all of the doors, opening or closing windows, opening or closing vehicle enclosures, activating or deactivating a guard mode, activating or deactivating alarm monitoring, or triggering an alarm, or a combination thereof.

In some embodiments, the processing circuitry may be further configured to filter, using a noise filter, the accelerometer signal to attenuate noise from vehicle movement.

In accordance with some embodiments of the present disclosure, a non-transitory computer-readable medium is provided with non-transitory computer-readable instructions encoded thereon that, when executed by a processor, causes the processor to identify a presence of a user proximate to a vehicle, detect a gesture input based on an accelerometer signal, and, in response to detecting the gesture input, perform a vehicle action. For example, the gesture input may comprise two knocks within a period of time on a door of the vehicle, and the vehicle action may comprise locking or unlocking the door.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram of components of a system configured to improve user access to vehicle actions and functions, in accordance with some embodiments of the present disclosure;

FIG. 2 shows an illustrative diagram of a gesture input from a user on a door of a vehicle, in accordance with some embodiments of the present disclosure;

FIG. 3 shows a panel of example gesture inputs and corresponding vehicle actions when the vehicle is in an unlocked state, in accordance with some embodiments of the present disclosure;

FIG. 4 shows an illustrative example of a noise filtering process applied to a noisy gesture input signal, in accordance with some embodiments of the present disclosure;

FIG. 5 shows an illustrative flowchart of actions being performed when a user is leaving the vehicle, in accordance with some embodiments of the present disclosure;

FIG. 6 shows a panel of example gesture inputs and corresponding vehicle actions when the vehicle is in a locked state, in accordance with some embodiments of the present disclosure;

FIG. 7 shows an illustrative flowchart of actions being performed when a user is approaching the vehicle, in accordance with some embodiments of the present disclosure;

FIG. 8 shows a panel of example gesture inputs and corresponding vehicle actions that do not involve locking or unlocking the vehicle, in accordance with some embodiments of the present disclosure;

FIG. 9 shows a flowchart of illustrative steps of performing a vehicle action in response to a detected gesture input, in accordance with some embodiments of the present disclosure;

FIG. 10 shows a flowchart of illustrative steps of performing different vehicle actions in response to detected gesture inputs based on whether a user is proximate to a vehicle, in accordance with some embodiments of the present disclosure; and

FIG. 11 shows a flowchart of illustrative steps of performing vehicle actions in response to detecting a gesture input and a current state of a particular vehicle, in accordance with some embodiments of the present disclosure.

### DETAILED DESCRIPTION

A vehicle may be equipped to perform multiple functions and actions, including locking or unlocking the vehicle, opening or closing windows, or opening and closing vehicle enclosures, at the request of a user. However, processes for the user to request a vehicle action to be performed may be difficult or cumbersome. For example, the vehicle may require extra steps from the user, such as pulling out and scanning a device (e.g., a key fob). Alternatively, the vehicle may lock or unlock based on identifying a signal from a user device, such as via a Bluetooth Low Energy signal. However, due to interference in the identified signal from the user device, a user's intent may not always be clear. For example, it may sometimes be difficult to determine if a user is approaching or leaving the vehicle, and an incorrect vehicle action may be performed, such as locking the vehicle as the user approaches the vehicle.

Provided herein are systems and methods to quickly and accurately perform vehicle actions. In some embodiments, the user may be proximate to the vehicle and may input a gesture input that is detected by processing circuitry of the vehicle. In response to detecting the gesture input, a vehicle action may be performed. The performed vehicle action may depend on the detected gesture input. For example, the gesture input may be two knocks within a period of time, and the corresponding vehicle action may be locking or unlocking a door of the vehicle. The gesture input may also include multiple gestures, such that one or more vehicle actions are performed in response to the gesture input.

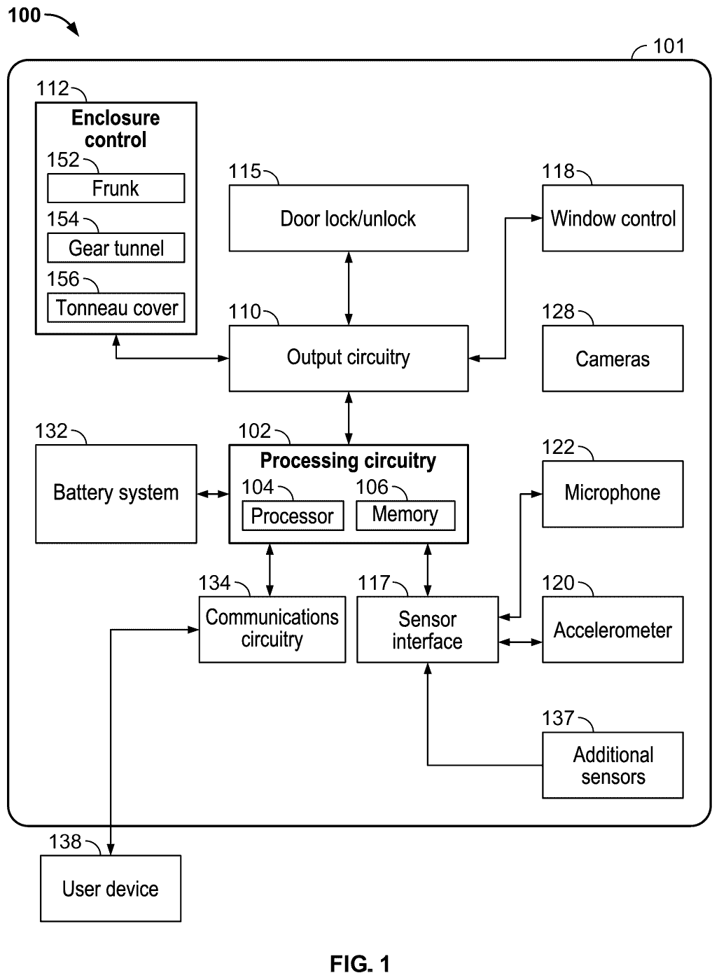

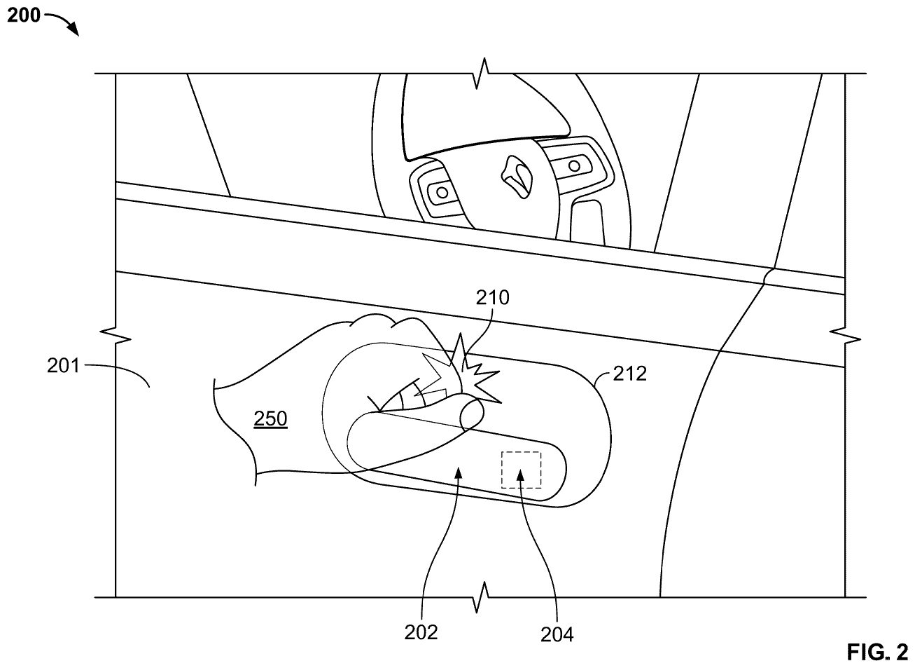

FIG. 1 shows a block diagram of components of a system 100 configured to improve user access to vehicle actions and functions, in accordance with some embodiments of the present disclosure. System 100 may comprise more or fewer than the components depicted in or described in reference to FIG. 1. Additionally, system 100 or any components thereof may be utilized for the components and/or operations described and/or depicted herein, for example, with respect to FIGS. 2-11. System 100 includes vehicle 101, which may be a car (e.g., a coupe, a sedan, a truck, an SUV, a sport utility vehicle, a full-size van, a minivan, a delivery van, a bus), a motorcycle, an aircraft (e.g., a drone), a watercraft (e.g., a boat), or any other type of vehicle. Vehicle 101 may include any kind of motor or motors capable of generating power (e.g., gas motors, gas-electric hybrids motors, electric motors, battery-powered electric motors, hydrogen fuel cell motors). In some embodiments, vehicle 101 may include a plurality of accelerometers configured to capture gesture inputs. For example, vehicle 101 may include a first vehicle door and a second vehicle door, where a first accelerometer may be located on the first vehicle door and a second accelerometer may be located on the second vehicle door.

As shown, vehicle 101 comprises processing circuitry 102 which may include processor 104 and memory 106. Processor 104 may comprise a hardware processor, a software processor (e.g., a processor emulated using a virtual machine), or any combination thereof. In some embodiments, the processing circuitry is part of an on-board computer that is configured to operate the vehicle. The on-board computer may include communications drivers that communicate with a user device 138. In some embodiments, processor 104 and memory 106 in combination may be referred to as processing circuitry 102 of vehicle 101. In some embodiments, processor 104 alone may be referred to as processing circuitry 102 of vehicle 101. Memory 106 may include hardware elements for non-transitory storage of commands or instructions, that, when executed by processor 104, cause processor 104 to operate vehicle 101 in accordance with embodiments described above and below. Processing circuitry 102 may be communicatively connected to components of vehicle 101 via one or more wires, or via wireless connections. For example, cameras 128 may capture images or videos, which may be received via sensor interface 117, and the received information may be processed by processing circuitry 102 and utilized to identify whether a user is proximate to vehicle 101 or as part of a vehicle guard mode system (e.g., a gear guard mode).

Processing circuitry 102 may be communicatively connected to a sensor interface 117, which interfaces with one or more accelerometers 120, one or more microphones 122, and additional sensors 137. Additional sensors 137 may include at least one of a front sensor, a rear sensor, a truck bed sensor, a left side sensor, a right side sensor, or a cable sensor and may be positioned at a variety of locations of vehicle 101, and may comprise one or more of a variety of sensor types (e.g., one or more of an image sensor, an ultrasonic sensor, a radar sensor, or a LIDAR sensor). The sensors that interface with sensor interface 117 may be used to capture gesture inputs and the presence of the user proximate to vehicle 101. Processing circuitry 102 may identify the presence of the user and detect gesture inputs based on sensor information received from sensor interface 117.

Processing circuitry 102 may be communicatively connected to battery system 132, which may be configured to provide power to one or more of the components of vehicle 101 during operation. In some embodiments, vehicle 101 may be an electric vehicle or a hybrid electric vehicle. In some embodiments, a plurality of battery cells may be packaged together to create one or more battery modules or assemblies to store energy and release the energy upon request.

Processing circuitry 102 may be communicatively connected to output circuitry 110, which may be configured to control certain functions and components of vehicle 101. For example, the output circuitry 110 may be connected to at least an enclosure control system 112 that controls the opening and closing of at least a frunk 152, a gear tunnel 154, or a tonneau cover 156. The output circuitry 110 may also be connected to a vehicle door lock and unlock system 115, to a window control system 118, other vehicle systems, or a combination thereof. Processing circuitry 102 may be detect a gesture input (e.g., via information received from sensor interface 117) and in response cause a vehicle action to be performed by sending an instruction to the corresponding vehicle component via output circuitry 110.

Processing circuitry 102 may be connected to communications circuitry 134, which may be configured to receive a wireless signal that, for instance, may be transmitted from a user device 138 (e.g., that is carried by a user) in range of vehicle 101. In some embodiments, the communications circuitry 134 comprises a transceiver configured to receive the wireless signal. For example, communications circuitry 134 may include a Bluetooth transceiver and/or an ultra-wideband receiver. When a signal is received, communications circuitry 134 may transmit the signal or related information to processing circuitry 102 for processing (e.g., to identify the presence of a user proximate to vehicle 101). User device 138 may be a key fob, a cell phone, or any other device associated with the user which may be detected by vehicle 101.

It should be appreciated that FIG. 1 only shows some of the components of vehicle 101, and it will be understood that vehicle 101 also includes other elements commonly found in any assembly corresponding to a vehicle, such as a vehicle powered by substantially electronic powertrain (e.g., a motor, brakes, wheels, wheel controls, turn signals, etc.).

In some embodiments, the gesture detection may be a function or mode that can be controlled by the user via a mobile application, a central display within the vehicle, or an infotainment display system onboard the vehicle. The user may disable the gesture detection mode, for example, to prevent excessive locking and unlocking. In some embodiments, the user may disable the gesture detection within a geofenced area. For example, the user may park the vehicle in a garage within a home of the user, and disable the gesture detection mode via a mobile application in order to prevent locking and unlocking from occurring while the user moves around in the garage.

As described above, processing circuitry 102 may be configured to detect a gesture input from the user. The user may input a gesture directly onto vehicle 101 (e.g., by knocking on a door or door handle of vehicle 101) and accelerometer 120 may capture the gesture input. The gesture input may be represented in an accelerometer signal generated by accelerometer 120, which can be processed by the processing circuitry 102 to detect the gesture input. In response to the detecting the gesture input, the processing circuitry 102 may cause a vehicle action to be performed (e.g., locking or unlocking the door) via output circuitry 110.

FIG. 2 shows an illustrative diagram 200 of a gesture input 210 from a user 250 on a door 201 of vehicle 101, in accordance with some embodiments of the present disclosure. As shown, vehicle 101 includes a vehicle door 201, a door handle 202, and an accelerometer 204 that can capture gestures input within, for example, gesture input detection area 212. Diagram 200 shows gesture input 210 being made from a hand of user 250 within gesture input detection area 212. It will be understood that diagram 200 is merely illustrative and that other visual and/or physical components may be included or substituted in diagram 200 in other embodiments.

Vehicle door 201 may, for example, be a driver seat door, but may be any vehicle door on vehicle 101, such as a front passenger seat door, or a back seat door. It will be understood that vehicle 101 may include a plurality of vehicle doors. For example, vehicle door 201 may be a first vehicle door for the driver seat, and vehicle 101 may include a second vehicle door for the passenger seat, and third and fourth doors leading to the left and right sides of the back seat, respectively. It will be understood that when vehicle door 201 is depicted in a closed and locked state. For example, vehicle door 201 may have been manually closed by a user (e.g., user 250), or may be remotely closed (e.g., via a wireless signal transmitted by a remote user device 138 and received by a transceiver on vehicle 101). When vehicle door 201 is locked, the vehicle door 201 will not open or close until unlocked. In some embodiments, vehicle door 201 may correspond to a vehicle enclosure panel (e.g., a liftgate, gear tunnel door, or frunk)

Vehicle door 201 includes a door handle 202 attached or affixed thereon that a user 250 may use to open vehicle door 201, although other shapes, sizes, locations, and functions of door handle 202 may be utilized as well in other embodiments. Furthermore, if vehicle 101 includes a plurality of vehicle doors, and vehicle door 201 is a first vehicle door, then it will be understood that door handle 202 may be a first door handle on the first vehicle door, and that a second door handle may be attached or affixed on the second vehicle door. Door handle 202 may, for example, be a latch that pops or rotates out when the vehicle door 201 is unlocked (e.g., so that user 250 may grab onto door handle 202 and pull open vehicle door 201), and retracts when vehicle door 201 is locked. In another suitable example, door handle 202 may protrude from vehicle door 201 even if vehicle door 201 is locked, but it will not operably release a door latch to allow the user to pull open vehicle door 201 when locked.

As shown, door handle 202 includes an accelerometer 204 that is integrated therein, although it will be understood that different locations may be utilized in other embodiments. Additionally, it will be further understood that accelerometer 204 may be replaced with any suitable similar sensor that is able to detect a gesture input (e.g., gesture input 210), such as an IMU, an infrared motion sensor, microphone 122, camera 128, etc. In some embodiments, accelerometer 204 corresponds to accelerometer 120 of FIG. 1 and is coupled to processing circuitry 102 of vehicle 101. Accelerometer 204 may be configured to transmit an accelerometer signal (e.g., a variable voltage, where a larger acceleration causes a larger voltage signal be transmitted) to processing circuitry 102. In some embodiments, accelerometer 204 may be located in a different location that is not on door handle 202 but elsewhere on vehicle door 201. If vehicle door 201 is a first vehicle door, and vehicle 101 includes a second vehicle door, then it will be understood that accelerometer 204 may be a first accelerometer, and vehicle 101 may include a second accelerometer on the second vehicle door.

In some embodiments, gesture input 210 made by user 250 may include two knocks within a one second period of time (e.g., the second knock occurs within one second of the first knock). As shown, gesture input 210 is input within a gesture input detection area 212 that includes door handle 202 and a region of vehicle door 201 and that corresponds to the region where gesture input 210 will be detected by accelerometer 204. It will be understood that in other embodiments, gesture input detection area 212 may be larger or smaller than what is shown, and other locations may be configured to detect gesture inputs. In some embodiments, accelerometer 204 may be in another location, or a different sensor may be configured to detect gesture inputs, such as a camera or a microphone (e.g., where the microphone is configured to detect an audio input from the user). Furthermore, each sensor may have a separate gesture input detection area. For example, vehicle 101 may include a plurality of accelerometers, and each respective accelerometer may include a gesture input detection area. In another suitable example, a camera system including one or more cameras may be configured to detect the gesture input, and the gesture input detection area is within the field of view of the camera system.

As explained above, vehicle 101 may be configured to perform a vehicle action in response to detecting a gesture input from user 250. For example, if the gesture input 210 includes two knocks within a one second period of time, the corresponding vehicle action may be locking or unlocking of vehicle door 201. In some embodiments, a gesture input 210 may include multiple gestures in sequence. For example, the previously depicted two knocks (e.g., an initial gesture) may be followed with another knock (e.g., a subsequent gesture). In some embodiments, the initial gesture causes vehicle 101 to perform a first vehicle action and the subsequent gesture causes vehicle 101 to perform a second vehicle action. In some embodiments, the combined three knocks (i.e., the initial gesture in combination with the subsequent gesture) causes vehicle 101 to perform an action that is different than the first action. For example, the first action may be performed when the initial gesture is detected, but not when the subsequent gesture is also detected. Accordingly, different gesture motion sequences may correspond to different vehicle actions being performed.

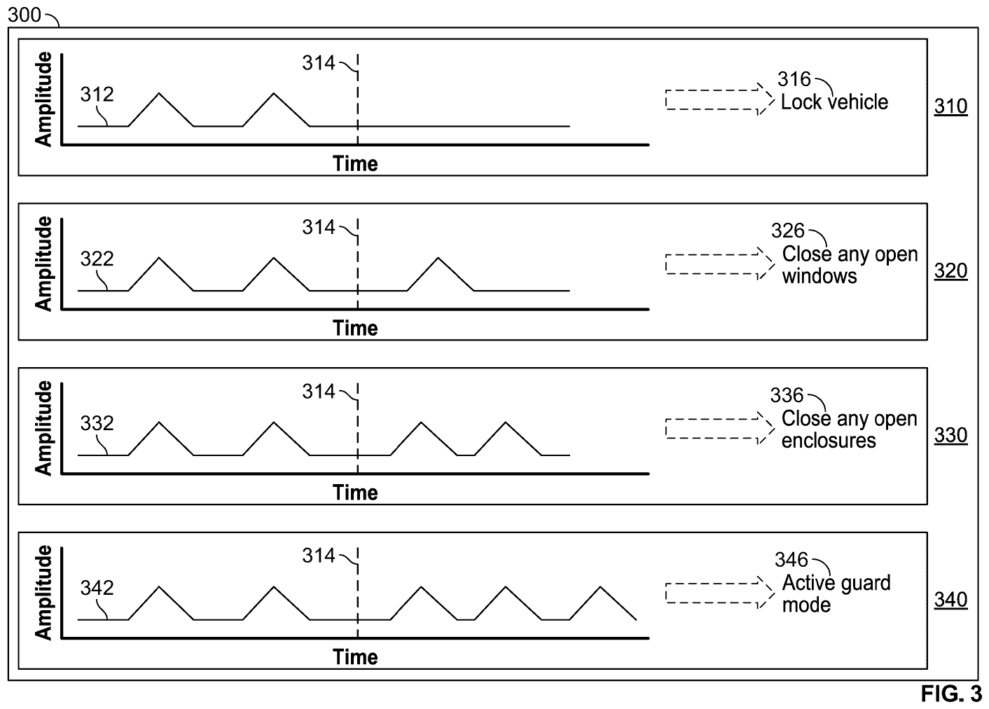

FIG. 3 shows a panel 300 of example gesture inputs and corresponding vehicle actions when the vehicle 101 is in an unlocked state, in accordance with some embodiments of the present disclosure. Vehicle 101 may be in the unlocked state when, for example, the user 250 exits vehicle 101. Panel 300 shows representations of gesture inputs 312, 322, 332, and 342 and corresponding vehicle actions 316, 326, 336, and 346. In some embodiments, gesture inputs 312, 322, 332, and 342 correspond to signals generated by a sensor such as accelerometer 120 or microphone 122 (e.g., a decibel level). It will be understood that the depicted signals are merely illustrative and they may take any other suitable forms, shapes, or patterns. Also, while four gesture inputs are shown, any number of gesture inputs may be used to perform any number of vehicle actions.

As shown, gesture input 312 includes two peaks occurring within a period of time indicated by one second indicator bar 314. In some embodiments, the two peaks correspond to two knocks on a vehicle door or door handle. When the user knocks on a vehicle door, the vibration or movement of the door may be detected by, for example, accelerometer 204. Accelerometer 204 may generate a signal that corresponds to gesture input 312 and processing circuitry 102 may process the accelerometer signal to detect gesture input 312. For example, processing circuitry 102 may detect gesture input 312 when two peaks in the accelerometer signal are identified within a period of time defined by one second indicator bar 314. The one second indicator bar 314 is an illustrative example of a period of time. In some embodiments, the period of time may be greater than one second (e.g., 1.5 seconds or 2.0 seconds) or less than one second (e.g., 0.5 seconds). When gesture input 312 is detected, vehicle action 316 is performed. As illustrated, the vehicle action is locking the vehicle. For example, when the user exits vehicle 101, gesture input 312 enables the user to quickly and easily lock vehicle 101 without having to retrieve a user device such as a key fob and making a selection to lock vehicle 101.

Gesture input 322 includes two peaks occurring within a period of time indicated by one second indicator bar 314 and an additional peak. In some embodiments, the three peaks correspond to three knocks on a vehicle door or door handle. Gesture 322 may be considered to include an initial gesture (i.e., gesture input 312) followed by a subsequent gesture (i.e., a single knock). In some embodiments, when a user knocks three times, processing circuitry 102 detects the first two knocks as gesture input 312 and locks the vehicle and then detects the third knock as gesture input 322 and performs vehicle action 326, which closes any open windows. In some embodiments, processing circuitry 102 may detect only detect gesture input 322 when the user knocks three times. For example, when processing circuitry 102 detects two knocks within a period of time, the processing circuitry 102 may wait a predetermined amount of time (e.g. 0.5 seconds) after the second knock was detected to determine if there is a third knock. If a third knock is not detected, then vehicle action 316 is performed. If a third knock is detected, then vehicle action 326 is performed instead. In some embodiments, when the third knock is detected both vehicle actions 316 and 326 are performed.

Gesture input 332 includes two peaks occurring within a period of time indicated by one second indicator bar 314 and two additional peaks. In some embodiments, the four peaks correspond to four knocks on a vehicle door or door handle. Similar to gesture input 322, gesture input 332 may also include an initial gesture (i.e., gesture input 312) followed by a subsequent gesture (i.e., two knocks). In some embodiments, when a user knocks four times, processing circuitry 102 detects the first two knocks as gesture input 312 and locks the vehicle, detects the third knock as gesture input 322 and performs vehicle action 326, which closes any open windows, and then detects the fourth knock as gesture input 332 and performs vehicle action 336, which closes any open enclosures on the vehicle (e.g., including a frunk, a gear tunnel, a tonneau cover, other suitable enclosures, or a combination thereof). In some embodiments, processing circuitry 102 may detect only detect gesture input 332 when the user knocks four times. For example, when processing circuitry 102 detects the initial gesture, processing circuitry 102 may wait a predetermined amount of time (e.g. 0.5 seconds) after the second knock was detected to determine if there is a third and fourth knock. If a third knock is not detected, the vehicle action 316 is performed. If the third knock is detected but not the fourth, vehicle action 326 is performed. If the third and fourth knocks are detected, then vehicle action 336 is performed. In some embodiments, when the third and fourth knocks are detected, vehicle actions 316, 326, and 336 are all performed.

Gesture input 342 has similar functions to that of gesture input 332, but includes two peaks occurring within a period of time (i.e., an initial gesture) indicated by one second indicator bar 314 and three additional peaks (i.e., a subsequent gesture). In some embodiments, when a user knocks five times, processing circuitry 102 detects the first two knocks as gesture input 312 and performs vehicle action 316, detects the third knock as gesture input 322 and performs vehicle action 326, detects the fourth knock as gesture input 332 and performs vehicle action 336, and then detects the fifth knock as gesture input 342 and performs vehicle action 346, which activates a guard mode of the vehicle. In some embodiments, processing circuitry 102 may only detect gesture input 342 when the user knocks five times. For example, when processing circuitry 102 detects the initial gesture, processing circuitry 102 may wait a predetermined amount of time (e.g. 0.5 seconds) after the second knock was detected to determine if there are more knocks. The performed vehicle action(s) may depend on whether a third, fourth, or a fifth knock are detected. In some embodiments, when the third, fourth, and fifth knock are detected, vehicle actions 316, 326, 336, and 346 are all performed.

While FIG. 3 provides illustrative examples of accelerometer or microphone signals representative of the gesture inputs from the user, it will be understood that other variations or combinations of gesture inputs and corresponding vehicle actions may be included or substituted in other embodiments. In some embodiments, the user may be able to configure different combinations of gesture inputs and corresponding vehicle actions. For example, the configuration may occur via a mobile application, or via a central infotainment display located within the vehicle. Additionally, it will be understood that the detected gesture inputs (e.g., via processing circuitry 102) may correspond to different types of sensor signals. For example, a camera system of the vehicle (e.g., similar to the previously described cameras 128) may also identify the user proximate to the vehicle, detect the gesture input from the user, generate a sensor signal to processing circuitry 102 to cause a vehicle action to be performed, or a combination thereof.

It should be noted that the example sensor signals 312, 322, 332, and 342 shown in FIG. 3 are simplified to illustrate the principles of the disclosure, and the sensor signals may take many forms other than those explicitly shown in FIG. 3. For example, accelerometer signals may be noisy due to gusts of wind, other passing vehicles causing ground vibrations, loud sounds causing vibrations, etc. Accordingly, noise filtering processes can be used to attenuate extraneous noise detected by the accelerometer or other types of sensors. For example, the noise filtering processes may include filtering the accelerometer signal through a high pass filter or a bandpass filter to attenuate frequencies outside the gesture frequency range. In another suitable example, a noise reference signal (e.g., an accelerometer signal generated from an accelerometer at a different location on vehicle 101) may be subtracted from a vehicle door accelerometer signal in order to attenuate noise. In a further suitable example, the noise reference signal may be subtracted from the door accelerometer signal, and the resulting signal may then be further processed via a high pass filter or a bandpass filter.

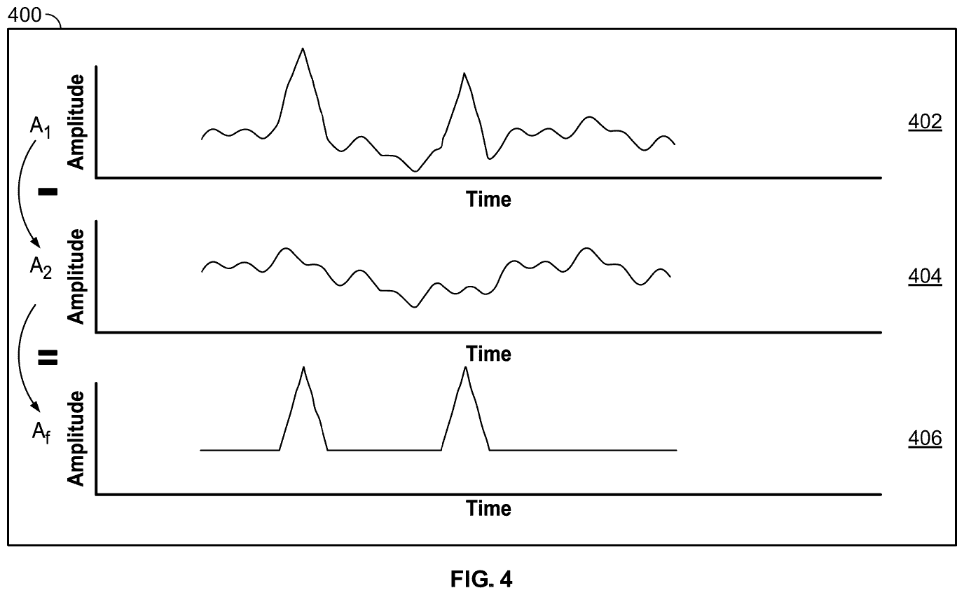

FIG. 4 shows an illustrative example of a noise filtering process 400 applied to a noisy gesture input signal 402, in accordance with some embodiments of the present disclosure. Noise filter process 400 may be used with any of the embodiments described above and below. Process 400 includes noisy gesture input signal 402 (i.e., A₁), a background noise signal 404 (A₂), and an output filtered signal 406 (A_{f}), although additional elements or processing steps may be included or substituted in other embodiments.

In some embodiments, noisy gesture input signal 402 (A₁) is an accelerometer signal output by an accelerometer (e.g., by accelerometer 204 in FIG. 2). For example, the accelerometer may be located on a door of the vehicle, and a gesture input may be input proximate to the accelerometer. It will be understood that noisy gesture input signal 402 includes the gesture input and additional noise. For example, the gesture input may be two knocks within a period of time, and the additional noise may be from passing traffic, or a combination of sources as previously described. As shown, for example, the included gesture input is represented in noisy gesture input signal 402 by two peaks and represents a gesture input that includes two knocks within a one second period of time.

Background noise signal 404 (A₂) is an accelerometer signal output by an accelerometer that includes noise but does not include a gesture input. In some embodiments, the accelerometer may be located on a different door on the same side of the vehicle and may be susceptible to the same noise. For example, general noise (e.g., from passing traffic, gusts of wind, etc.) may be included in both A₁ and A₂. However, because the gesture input is proximate to the accelerometer that generates A₁ and not proximate to the accelerometer that generates A₂, the vibration of the knocks will be mostly attenuated by the time the vibration reaches the accelerometer that generates A₂.

The background noise signal 404 (A₂) may be subtracted from the noisy gesture input signal 402 (A₁) in the noise filtering process 400 to attenuate the noise, with the resulting final signal being output as filtered signal 406 (A_{f}). As shown, filtered signal 406 has two peaks representing the gesture input that includes two knocks within a one second period of time, and reduced noise. In some situations, vehicle 101 will be able to more accurately identify gesture inputs using filtered signal 406 (A_{f}) compared to noisy gesture input signal 402 (A₁). However, it will be understood that noise filtering process 400 may not necessarily attenuate all of the noise in noisy gesture input signal 402. Additionally, it will be further understood that noise filtering process 400 may utilize different and/or additional operations and elements. In some embodiments, background noise signal 404 may be subtracted from noisy gesture input signal 402 as described, but the resulting signal may then be passed through a band-pass filter or a high pass filter before being output as filtered signal 406.

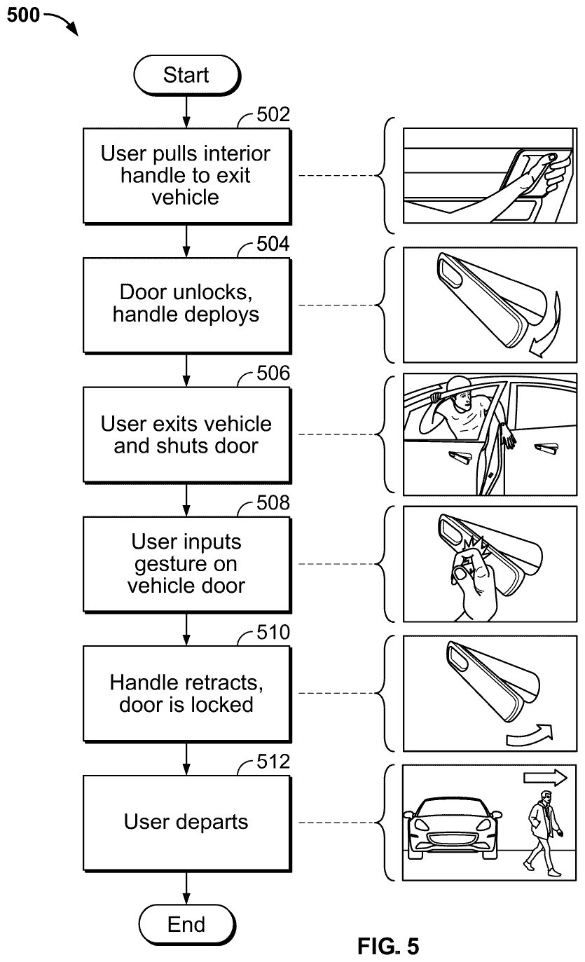

FIG. 5 shows an illustrative flowchart of actions being performed when a user is leaving the vehicle, in accordance with some embodiments of the present disclosure. Although FIG. 5 is described in the context of particular structures, components, processing, and user actions of the present disclosure, and although a particular order and flow of steps are depicted in FIG. 5, it will be understood that in some embodiments, one or more of the steps may be modified, moved, removed, or added, and that the order of steps depicted in FIG. 5 may be modified.

Process 500 begins at step 502, where a user inside a vehicle pulls an interior handle on a vehicle door to exit the vehicle. For example, the user may park the vehicle and then subsequently exit the vehicle as described above. Processing may then continue to step 504.

At step 504, in response to pulling the interior handle of the vehicle door, the vehicle unlocks the door and disengages a door latch, allowing the user the push open the door. As shown, the unlocking of the vehicle door is indicated by a handle of the door deploying, but it will be understood that other visual and/or physical elements may be utilized, as long as the vehicle door is unlocked. In some embodiments, steps 502 and steps 504 may be combined or modified. For example, the user may instead start exterior to the vehicle, the vehicle door may start unlocked, or a combination thereof. However, it will be understood that the vehicle door is in an unlocked state after step 504. Processing may then continue to step 506.

At step 506, the user exits the vehicle and shuts the door. In some embodiments, the user may start exterior to the unlocked vehicle door and the door may be already shut, and therefore step 506 is omitted. Processing then continues to step 508.

At step 508, the user inputs a gesture on the vehicle door. In some embodiments, the gesture input includes two knocks within a one second period of time. However, it will be understood that the gesture input may also include a plurality of gestures (e.g., as depicted in FIG. 3). The gesture input is then detected by the vehicle. For example, the gesture input may be detected by processing circuitry 102 detecting a pattern of peaks in an accelerometer signal generated from an accelerometer integrated in the door handle (e.g., as described in FIG. 2), or by a microphone on the vehicle. Processing may then continue to step 510.

At step 510, in response to the detected gesture input (e.g., the two knocks within a one second period of time), the vehicle door is locked. In some embodiments, the vehicle door locking is represented by the door handle retracting. In a previously described embodiment where the gesture input includes a plurality of gestures (e.g., such as the inputs detected after the one second indicator bar 314 in FIG. 3), additional vehicle actions may be performed at step 510 in response to the additional gestures. Processing may then continue to step 512.

At step 512, the user departs and leaves the proximity of the vehicle. It will be understood that the user may leave while vehicle action(s) are being performed, and that the vehicle action(s) may continue to be performed even after the user has left the proximity of the vehicle.

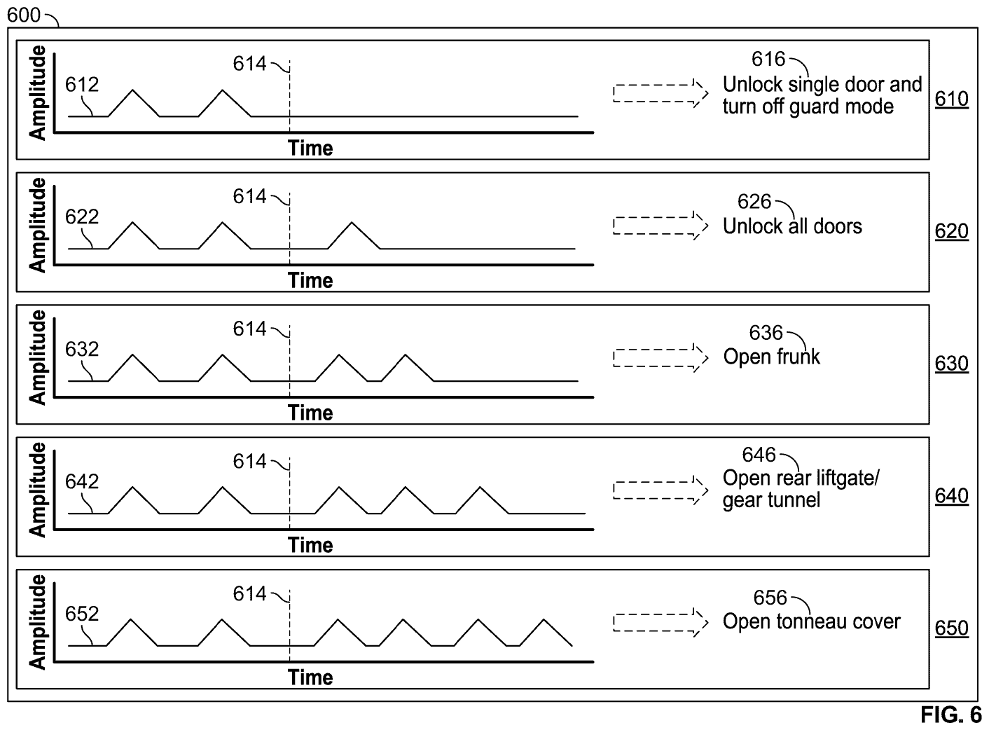

FIG. 6 shows a panel 600 of example gesture inputs and corresponding vehicle actions when the vehicle 101 is in a locked state, in accordance with some embodiments of the present disclosure. Vehicle 101 may be in the locked state when, for example, the user 250 is approaching or returning to vehicle 101. It will be understood that the design of panel 600 is similar to that of panel 300, but with vehicle 101 in the locked state. Panel 600 shows representations of gesture inputs 612, 622, 632, 642, and 652 and corresponding vehicle actions 616, 626, 636, 646, and 656. In some embodiments, gesture inputs 612, 622, 632, 642, and 652 correspond to signals generated by a sensor such as accelerometer 120 or microphone 122. Similar to FIG. 3, it will be understood that the depicted signals are merely illustrative and they may take any other suitable forms, shapes, or patterns, and that any number of gesture inputs may be used to perform any number of vehicle actions.

As shown, gesture input 612 includes two peaks occurring within a period of time indicated by one second indicator bar 614 (e.g., similar to one second indicator bar 314 in FIG. 3). In some embodiments, the two peaks correspond to two knocks on a vehicle door or door handle. As described above, when the user knocks on a vehicle door, the vibration or movement of the vehicle door may be detected by, for example, accelerometer 204. Accelerometer 204 may generate a signal that corresponds to gesture input 612 and processing circuitry 102 may process the accelerometer signal to detect gesture input 612. For example, processing circuitry 102 may detect gesture input 612 when two peaks in the accelerometer signal are identified within a period of time defined by one second indicator bar 614. The one second indicator bar 614 is an illustrative example of a period of time. In some embodiments, the period of time is greater than one second (e.g., 1.5 seconds or 2.0 seconds) or less than one second (e.g., 0.5 seconds). When gesture input 612 is detected, vehicle action 616 is performed. The vehicle action is unlocking a single door of the vehicle (e.g., the door that received the gesture input). In some embodiments, when a guard mode is turned on, vehicle action 616 also includes the action of turning off the guard mode as illustrated. Gesture input 612 enables the user to quickly and easily unlock a door of vehicle 101 without having to retrieve a user device such as a key fob and making a selection to unlock the door when approaching the vehicle 101.

Gesture input 622 includes two peaks occurring within a period of time indicated by one second indicator bar 614 and an additional peak. In some embodiments, the three peaks correspond to three knocks on a vehicle door or door handle. Gesture 622 may be considered to include an initial gesture (i.e., gesture input 612) followed by a subsequent gesture (i.e., a single knock). In some embodiments, when a user knocks three times, processing circuitry 102 detects the first two knocks as gesture input 612 and unlocks one door and then detects the third knock as gesture input 622 and performs vehicle action 626, which unlocks all doors on vehicle 101. In some embodiments, processing circuitry 102 may detect only detect gesture input 622 when the user knocks three times. For example, when processing circuitry 102 detects two knocks within a period of time, processing circuitry 102 may wait a predetermined amount of time (e.g. 0.5 seconds) after the second knock was detected to determine if there is a third knock. If a third knock is not detected, then vehicle action 616 is performed. If a third knock is detected, then vehicle action 626 is performed instead.

Gesture input 632 includes two peaks occurring within a period of time indicated by one second indicator bar 614 and two additional peaks (e.g., similar to gesture input 332 in FIG. 3). In some embodiments, when a user knocks four times and vehicle 101 is locked, processing circuitry 102 detects the first two knocks as gesture input 612 and unlocks one door, then detects the third knock as gesture input 622 and performs vehicle action 626, which unlocks all doors on vehicle 101, and then detects the fourth knock as gesture input 632 and performs vehicle action 636, which opens a frunk (e.g., frunk 152) of the vehicle. In some embodiments, processing circuitry 102 may detect only detect gesture input 632 when the user knocks four times. For example, when processing circuitry 102 detects two knocks within a period of time, processing circuitry 102 may wait a predetermined amount of time (e.g. 0.5 seconds) after the second knock was detected to determine if there is a third and fourth knock. If the third knock is not detected, then vehicle action 616 is performed. If only the third knock is detected, then vehicle action 626 is performed instead. If both the third and the fourth knocks are detected, then vehicle action 636 is performed. In some embodiments, when the third and fourth knocks are detected, vehicle actions 616, 626, and 636 are all performed.

Gesture input 642 has similar functions to that of gesture input 632, but includes two peaks occurring within a period of time (i.e., an initial gesture) indicated by one second indicator bar 614 and three additional peaks (i.e., a subsequent gesture). In some embodiments, when a user knocks five times, processing circuitry 102 detects the first two knocks as gesture input 612 and performs vehicle action 616, detects the third knock as gesture input 622 and performs vehicle action 626, detects the fourth knock as gesture input 632 and performs vehicle action 636, and then detects the fifth knock as gesture input 642 and performs vehicle action 646, which opens a rear liftgate or a gear tunnel of the vehicle. In some embodiments, processing circuitry 102 may only detect gesture 642 when the user knocks five times. For example, when processing circuitry 102 detects the initial gesture, processing circuitry 102 may wait a predetermined amount of time (e.g., 0.5 seconds) after the second knock was detected to determine if there are more knocks. The performed vehicle action(s) may depend on whether a third, fourth, or fifth knock is detected. In some embodiments, when the third, fourth, and fifth knocks are detected, vehicle actions 616, 626, 636, and 646 are all performed.

Gesture input 652 has similar functions to that of gesture input 642, but includes two peaks occurring within a period of time (i.e., an initial gesture) indicated by one second indicator bar 614 and four additional peaks (i.e., a subsequent gesture). In some embodiments, when a user knocks six times, processing circuitry 102 detects the first five knocks as gesture inputs 612, 622, 632, and 642 as previously described, and performs vehicle actions 616, 626, 636, and 646, respectively. The sixth knock is then detected as the fifth gesture input 652, and vehicle action 656 is performed, which opens a tonneau cover of the vehicle (e.g., the tonneau cover 156 in FIG. 1). In some embodiments, processing circuitry 102 may only detect gesture 652 when the user knocks six times. For example, when processing circuitry 102 detects the initial gesture, processing circuitry 102 may wait a predetermined amount of time (e.g., 0.5 seconds) after the second knock was detected to determine if there are more knocks. The performed vehicle action(s) may depend on whether a third, fourth, fifth, or sixth knock was detected. In some embodiments, when the third, fourth, fifth, and sixth knocks are detected, vehicle actions 616, 626, 636, 646, and 656 are all performed.

Similar to FIG. 3, it will be understood that other variations or combinations of gesture inputs and corresponding vehicle actions not shown in panel 600 may be included or substituted in other embodiments. Also, other sensors on the vehicle may detect the gesture input from the user and generate and provide a sensor signal to processing circuitry 102, which can determine whether a corresponding vehicle action should be performed. The example sensor signals 612, 622, 632, 642, and 652 are simplified in FIG. 6 to illustrate the principles of this disclosure, and may be noisy and/or take other forms than those explicitly shown in FIG. 6.

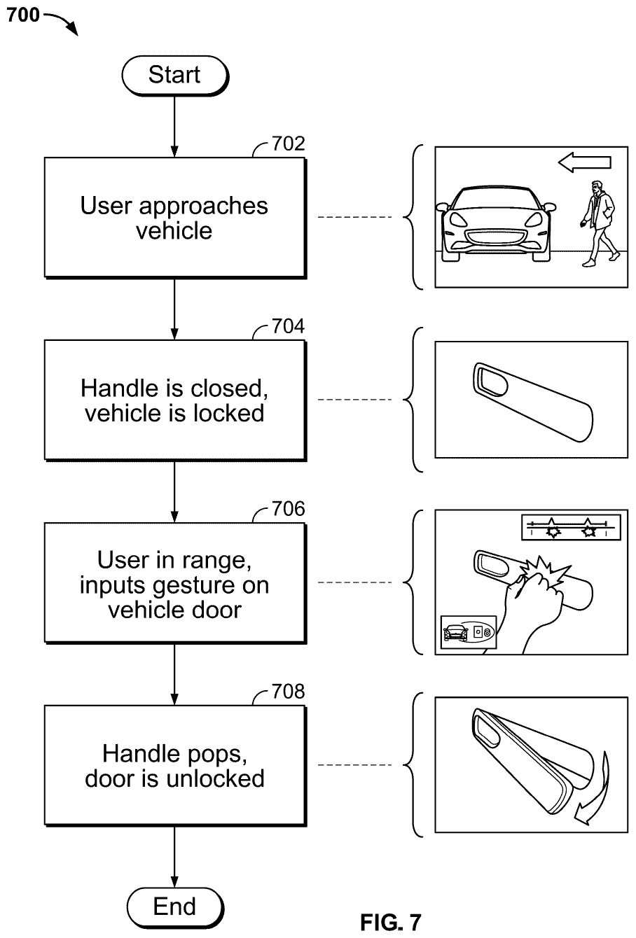

FIG. 7 shows an illustrative flowchart of actions being performed when a user is approaching the vehicle, in accordance with some embodiments of the present disclosure. Although FIG. 7 is described in the context of particular structures, components, processing, and user actions of the present disclosure, and although a particular order and flow of steps are depicted in FIG. 7, it will be understood that in some embodiments, one or more of the steps may be modified, moved, removed, or added, and that the order of steps depicted in FIG. 7 may be modified.

Process 700 begins at step 702, where a user approaches a vehicle. In some embodiments, the user may carry a user device that transmits a wireless signal, and the vehicle may receive the wireless signal from the user device (e.g., via a transceiver on the vehicle). Processing circuitry in the vehicle may utilize the received wireless signal and identify that the user is proximate to the vehicle. Processing may then continue to step 704.

At step 704, the user has approached the vehicle, and the vehicle is in the locked state. In some embodiments, the user may approach a particular door on the vehicle. As shown, the locked vehicle door is represented by a handle on a vehicle door being closed and retracted in the vehicle, but it will be understood that other visual and/or physical elements may be utilized, as long as the vehicle door is locked. Processing may then continue to step 706.

At step 706, the user is proximate to the vehicle and inputs a gesture onto the vehicle door. In some embodiments, the gesture input includes two knocks within a one second period of time. However, it will be understood that the gesture input may also include a plurality of gestures (e.g., as depicted in FIG. 6). The gesture input is then detected by the vehicle. For example, the gesture input may be detected by processing circuitry 102 detecting a pattern of peaks in an accelerometer signal generated from an accelerometer integrated in the door handle (e.g., as described in FIG. 2.), or by a microphone on the vehicle. Processing may then continue to step 708.

At step 708, in response to the detected gesture input, the vehicle door is unlocked. In some embodiments, the vehicle door unlocking is represented by the door handle deploying outwards, and the door handle may be electronically or mechanically engaged with a door latch enabling the user to pull the door handle to open the vehicle door. It will be understood that if the gesture input includes a plurality of gestures, additional vehicle actions may be performed at step 708 in response to the additional gestures.

The gesture inputs of FIGS. 3 and 6 have an initial two knock gesture that locks or unlocks the vehicle, depending on the current lock or unlock state of the vehicle. It will be understood that other gesture inputs may correspond to vehicle actions that do not have an initial gesture input that locks or unlocks the vehicle.

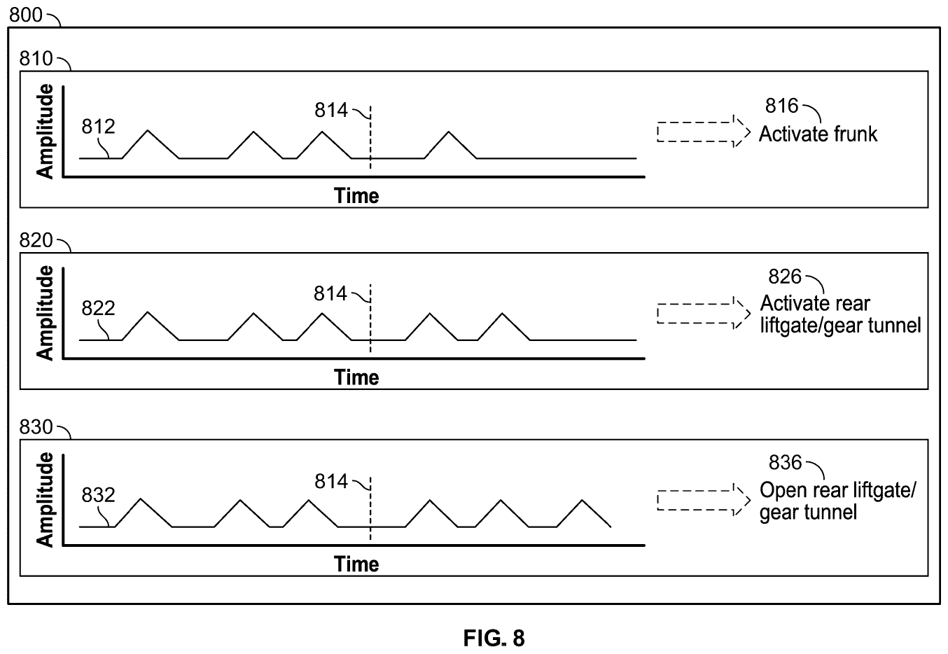

FIG. 8 shows a panel 800 of example gesture inputs and corresponding vehicle actions that do not involve locking or unlocking the vehicle 101, in accordance with some embodiments of the present disclosure. It will be understood that the design of panel 800 is similar to that of panels 300 and 600, but that the initial gesture for the examples illustrated in panel 800 includes three knocks within a period of time, instead of two knocks within a period of time). Furthermore, it will be understood that the depicted signals are merely illustrative and they may take any suitable forms, shapes, or patterns, and that any number of gesture inputs may be used to perform any number of vehicle actions.

As shown, gesture input 812 includes three peaks occurring within a period of time indicated by one second indicator bar 814 (e.g., similar to one second indicator bar 314 in FIG. 3), and an additional peak thereafter. In some embodiments, the four peaks correspond to four knocks on a vehicle door or door handle. As described above, when the user knocks on a vehicle door, the vibration or movement of the vehicle door may be detected by, for example, accelerometer 204. Accelerometer 204 may generate a signal that corresponds to gesture input 812 and processing circuitry 102 may process the accelerometer signal to detect gesture input 812. For example, the one second indicator bar 814 depicts an example of a period of time, and processing circuitry 102 may detect gesture input 812 when three peaks in the accelerometer signal are identified within the period of time, followed by a subsequent peak. In some embodiments, the period of time is greater than one second (e.g., 1.5 seconds or 2.0 seconds) or less than one second (e.g., 0.5 seconds). When gesture input 812 is detected, vehicle action 816 is performed. As illustrated, the vehicle action is activating a frunk (e.g., frunk 152), and it is noted that the frunk is activated (e.g., opened or closed) without locking or unlocking a door of the vehicle. For example, gesture input 812, which involves more rapid knocking, allows the user to quickly access items stored in the frunk while keeping the vehicle locked (e.g., if the user does not want to enter or drive the vehicle).

Gesture input 822 includes three peaks occurring within a period of time indicated by one second indicator bar 814 and two additional peaks. In some embodiments, processing circuitry 102 only detects gesture input 822 when the user knocks five times. For example, when processing circuitry 102 detects three knocks within a period of time, processing circuitry 102 may wait a predetermined amount of time (e.g. 0.5 seconds) after the third knock was detected to determine if there is a fourth or fifth knock. If only the fourth knock is detected, then vehicle action 816 is performed. If both the fourth and fifth knocks are detected, then only vehicle action 826 is performed, which activates (e.g., opens or closes) a rear liftgate or gear tunnel of the vehicle.

Gesture input 832 includes three peaks occurring within a period of time indicated by one second indicator bar 814 and three additional peaks. In some embodiments, processing circuitry 102 only detects gesture input 832 when the user knocks six times. For example, when processing circuitry 102 detects three knocks within a period of time, processing circuitry 102 may wait a predetermined amount of time (e.g. 0.5 seconds) after the third knock was detected to determine if there is a fourth, fifth, or sixth knock. If only the fourth knock is detected, then vehicle action 816 is performed. If only the fourth and fifth knocks are detected, then vehicle action 826 is performed. If the fourth, fifth, and sixth knocks are detected, then vehicle action 836 is performed, which activates (e.g., opens or closes) a tonneau cover of the vehicle.

The gesture inputs of FIG. 8 enable a user to activate specific vehicle functions by using a three quick knocks when, for example, the user does not wish to lock or unlock a vehicle. In addition, similar to FIG. 6, it will be understood that other variations or combinations of gesture inputs and corresponding vehicle actions not shown in panel 800 may be included or substituted in other embodiments. Also, other sensors on the vehicle may detect the gesture input from the user and generate and provide a sensor signal to processing circuitry 102, which can determine whether a corresponding vehicle action should be performed. The example signals 812, 822, and 832 are simplified in FIG. 8 to illustrate the principles of this disclosure, and may be noisy and/or take other forms than those explicitly shown in FIG. 8.

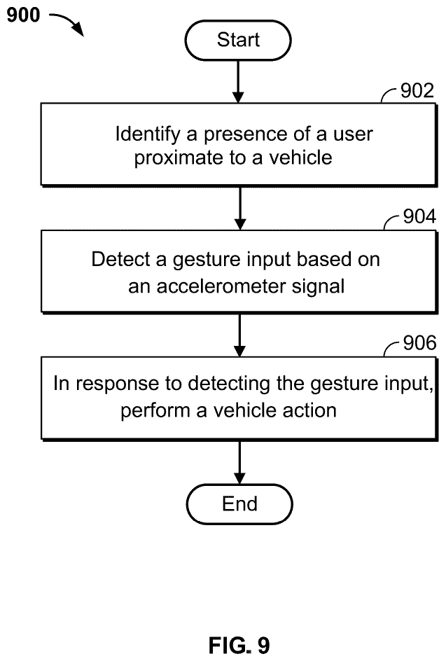

FIG. 9 shows a flowchart of illustrative steps of performing a vehicle action in response to a detected gesture input, in accordance with some embodiments of the present disclosure. Although FIG. 9 is described in the context of the particular structures, components, and processing of the present disclosure, and although a particular order and flow of steps are depicted in FIG. 9, it will be understood that in some embodiments, one or more of the steps may be modified, moved, removed, or added, and that the order of steps depicted in FIG. 9 may be modified.

Process 900 begins at step 902, where a presence of a user proximate to a vehicle is identified. In some embodiments, a transceiver (e.g., as part of communications circuitry 134 of vehicle 101) may detect a short-range wireless signal of a user device associated with the user (e.g., a cell phone that belongs to the user, a key fob, etc.). In one example, the wireless signal is a Bluetooth Low Energy (BLE) signal. Processing circuitry 102 of the vehicle 101 may identify the presence of the user proximate to the vehicle when a signal is detected from user device 138. In some embodiments, the processing circuitry 102 identifies the presence of the user proximate to the vehicle when the signal strength of the signal detected from user device 138 is greater than a threshold. In some embodiments, other types of sensors may be used to detect the presence of the user proximate to vehicle 101. For example, cameras 128 may capture images of the environment around vehicle 101 and image processing by processing circuitry 102 may be used to identify the presence of the user. Once the presence of the user proximate to vehicle 101 is identified, the processing may then continue to step 904.

At step 904, a gesture input is detected (e.g., via processing circuitry 102 of vehicle 101) based on a sensor signal. In some embodiments, the user performs a gesture and the gesture is captured by a sensor of vehicle 101. For example, when the user knocks on a door of vehicle 101, the vibration or movement of the door can be captured by an accelerometer 204 integrated in the vehicle door as a gesture input. The accelerometer signal is provided to processing circuitry 102, which may detect the gesture input in the accelerometer signal (e.g., as a pattern of peaks). In another example, a microphone sensor may be used to capture the sound of the user's gesture. For example, when the user knocks on the door of vehicle 101, a microphone located on or near the door can pick up the sound of the knocks. Processing circuitry 102 can process the microphone signal (e.g., a decibel level) to detect the gesture input by identifying peaks in the microphone signal. As yet another example, cameras 128 may capture images of the environment around vehicle 101 and capture video images of the user's gesture. Processing circuitry 102 can process the video images to detect the gesture input as a sequence of user motions. Processing may then continue to step 906.

At step 906, a vehicle action is performed in response to detecting the gesture input. In some embodiments, the gesture input may include two knocks within a one second period of time, and the corresponding vehicle action may be unlocking or locking the vehicle door. In some embodiments, the gesture input may further include subsequent gestures or different types of gesture inputs (e.g., as depicted in FIGS. 3, 6, and 8), and additional or other vehicle actions may be performed in response to detecting the subsequent or different types of gestures.

It will be understood that FIG. 9 depicts the vehicle action being performed in response to a detected gesture input. However, in some embodiments, whether the vehicle action is performed also depends on whether the user was identified as being proximate to the vehicle (e.g., the result of step 902). This may prevent an unauthorized user from making a gesture input and causing the vehicle to unlock or open a vehicle enclosure. In some embodiments, the vehicle action that is performed depends on the gesture input (e.g., a knock pattern) and on the current state of the vehicle (e.g., whether the vehicle door(s) is locked or unlocked, whether enclosures on the vehicle are open or closed, etc.).

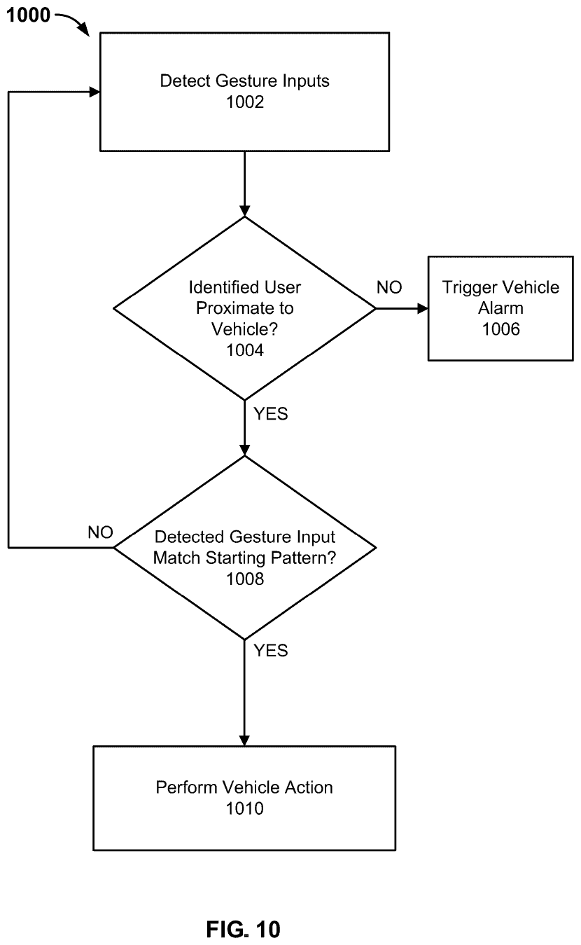

FIG. 10 shows a flowchart of illustrative steps of performing different vehicle actions in response to detected gesture inputs based on whether a user is proximate to a vehicle, in accordance with some embodiments of the present disclosure. Similar to FIG. 9, FIG. 10 is described in the context of the particular structures, components, and processing of the present disclosure, and depicts a particular order and flow of steps. However, it will be understood that in some embodiments, one or more of the steps may be modified, moved, removed, or added, and that the order of steps depicted in FIG. 10 may be modified.

Process 1000 begins at step 1002, where a gesture input is detected. The gesture input may be detected by processing circuitry 102 of vehicle 101. It will be understood that step 1002 may correspond to step 904 of FIG. 9 and the gesture input may include any gesture input or combination of gesture inputs as described herein (e.g., as depicted in FIGS. 3, 6, and 8). Processing then continues to step 1004.

At step 1004, the vehicle 101 determines whether the user (e.g., an owner or authorized user) is proximate to vehicle 101. In some embodiments, the processing of step 1004 includes the processing of step 902 of FIG. 9. For example, processing circuitry 102 may detect whether the user is proximate to vehicle 101 based on a whether a signal is detected from user device 138 and/or whether the user is identified in an images capture by one of cameras 128. If the user is not identified as being proximate to the vehicle (“NO” to step 1004), processing may then continue to step 1006. If the user is identified as being proximate to the vehicle (“YES” to step 1004), processing may then continue to step 1008.

At step 1006, a vehicle alarm is triggered in response to detecting a gesture input on the vehicle but not identifying the user proximate to the vehicle. For example, the alarm will be triggered if an unknown or unauthorized person or object strikes the vehicle repeatedly (e.g., in an attempt to break into the vehicle). In some embodiments, additional vehicle actions may also be performed either in place of or in tandem with triggering the alarm, such as alerting the user by sending a message to user device 138.

At step 1008, the processing circuitry 102 of vehicle 101 determines whether the detected gesture input is valid (e.g., matches a stored gesture). In some embodiments, vehicle 101 stores a plurality of gestures (e.g., gesture patterns and/or criteria) in memory 106. When a gesture input is detected and the user is proximate to the vehicle, processing circuitry 102 compares the gesture input with the stored gestures to determine if there is a match. If the gesture input includes a valid gesture input (“YES” to step 1008), processing may continue to step 1010. If the gesture input does not include a valid gesture input (“NO” to step 1008), processing returns to step 1002.

At step 1010, a vehicle action is performed in response to the detected gesture input. Step 1010 may correspond to step 906 of FIG. 9. In some embodiments, the gesture input may include two knocks within a one second period of time, and the corresponding vehicle action may be unlocking or locking the vehicle door. In some embodiments, the gesture input may further include subsequent gestures or different types of gesture inputs (e.g., as depicted in FIGS. 3, 6, and 8), and additional or other vehicle actions may be performed in response to detecting the subsequent or different types of gestures.

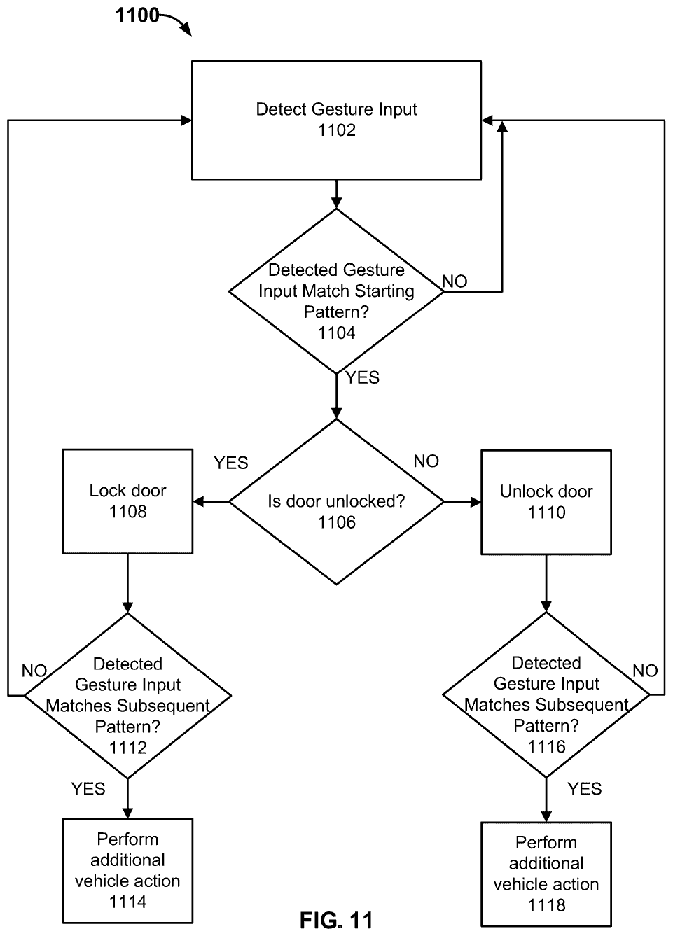

FIG. 11 shows a flowchart 1100 of illustrative steps of performing vehicle actions in response to detecting a gesture input and a current state of a particular vehicle, in accordance with some embodiments of the present disclosure. Similar to FIGS. 9 and 10, FIG. 11 is described in the context of the particular structures, components, and processing of the present disclosure, and depicts a particular order and flow of steps. However, it will be understood that in some embodiments, one or more of the steps may be modified, moved, removed, or added, and that the order of steps depicted in FIG. 11 may be modified.

Processing begins at step 1102, where a gesture input is detected. The gesture input may be detected by processing circuitry 102 of vehicle 101. It will be understood that step 1102 may correspond to step 904 of FIG. 9 and the gesture input may include any gesture input or combination of gesture inputs as described herein (e.g., as depicted in FIGS. 3, 6, and 8). Processing then continues to step 1104.

At step 1104, the processing circuitry 102 of vehicle 101 determines whether the detected gesture input matches a starting pattern (e.g., for an initial gesture such as gesture input 312 or 612). For example, the starting pattern may be two knocks within a one second period of time. However, it will be understood that the starting pattern may be any starting pattern that corresponds to an initial gesture. It will be understood that step 1104 may correspond and function similar to step 1008 of FIG. 10. If the detected gesture input matches an initial gesture (“YES” to step 1104), processing may then continue to step 1106. If the detected gesture input does not match an initial gesture (“NO” to step 1104), processing returns to step 1102.

At step 1106, the processing circuitry 102 of vehicle 101 determines whether a door of the vehicle is locked or unlocked. For example, the processing circuitry 102 may determine whether the door on which the gesture input was received is locked or unlocked. As another example, the processing circuitry 102 may determine whether the vehicle is in a locked or unlocked state. If the door is unlocked (“YES” to 1106), processing may continue to step 1108, and if the door is locked (“NO” to 1106), processing may continue to step 1110.

At step 1108, in response to detecting that the gesture input matches the initial gesture and that the door is unlocked, the processing circuitry 102 causes the vehicle door to be locked. For example, the initial gesture may correspond to gesture 312, where the vehicle action is locking of vehicle. It will be understood that a different initial gesture may result in a different vehicle action being performed. Processing then continues to step 1112.

At step 1110, in response to detecting that the gesture input matches the initial gesture and that the door is locked, the processing circuitry 102 causes the vehicle door to be unlocked. For example, the initial gesture may correspond to gesture 612, where the vehicle action is unlocking of the door of vehicle. In some embodiments at step 1110, all of the vehicle doors are unlocked and/or a guard mode is turned off. It will be understood that, similar to step 1108, a different initial gesture may result in a different vehicle action being performed. Processing then continues to step 1116.

At step 1112, the processing circuitry 102 determines whether the detected gesture input matches a subsequent pattern after the initial gesture. For example, as depicted by FIG. 3, a gesture input may include subsequent gestures after the initial gesture, such as an additional knock, two additional knocks, or three additional knocks. If the detected gesture input matches a subsequent pattern after the initial gesture (“YES” to 1112), processing may continue to step 1114. If the detected gesture input does not match a subsequent pattern after the initial gesture (“NO” to 1112), processing returns to step 1102.

At step 1114, the processing circuitry 102 causes one or more additional vehicle actions to performed in response to the subsequent pattern of the detected gesture input. Examples of additionally performed vehicle actions are depicted and described, for example, in connection with FIG. 3.

At step 1116, the processing circuitry 102 determines whether the detected gesture input matches a subsequent pattern after the initial gesture. For example, as depicted by FIG. 6, a gesture input may include subsequent gestures after the initial gesture, such as an additional knock, two additional knocks, three additional knocks, or four additional knocks. If the detected gesture input matches a subsequent pattern after the initial gesture (“YES” to 1116), processing may then continue to step 1118. If the detected gesture input does not match a subsequent pattern after the initial gesture (“NO” to 1116), processing returns to step 1102.

At step 1118, the processing circuitry 102 causes one or more additional vehicle actions to be performed in response to the subsequent pattern of the detected gesture input. Examples of additionally performed vehicle actions are depicted and described, for example, in connection with FIG. 6.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following paragraphs.

While some portions of this disclosure may refer to examples, any such reference is merely to provide context to the instant disclosure and does not form any admission as to what constitutes the state of the art.

What is claimed is:

1. A method, comprising:
identifying, using processing circuitry, a presence of a user proximate to a vehicle;
detecting, using the processing circuitry, a gesture input based on an accelerometer signal; and
in response to detecting the gesture input, performing a vehicle action.

2. The method of claim 1, wherein detecting the gesture input comprises detecting two knocks within a period of time on a door of the vehicle.

3. The method of claim 2, wherein the vehicle action comprises locking or unlocking the door.

4. The method of claim 1, wherein an accelerometer generates the accelerometer signal and is located on or within a door handle of the vehicle.

5. The method of claim 1, wherein:
the gesture input is one of a plurality of different detectable gesture inputs; and
each one of the plurality of different detectable gesture inputs corresponds to a different vehicle action.

6. The method of claim 1, wherein identifying the presence of the user comprises detecting a short-range wireless signal of a user device.

7. The method of claim 1, further comprising:
in response to detecting the gesture input and not identifying the presence of the user proximate to the vehicle, triggering an alarm of the vehicle.

8. The method of claim 1, wherein the vehicle action comprises locking or unlocking a single door, locking or unlocking all of the doors, opening or closing windows, opening or closing vehicle enclosures, activating or deactivating a guard mode, activating or deactivating alarm monitoring, or triggering an alarm, or a combination thereof.

9. The method of claim 1, further comprising:
filtering, using a noise filter, the accelerometer signal to attenuate noise from vehicle movement.

10. A vehicle, comprising:
an accelerometer configured to generate an accelerometer signal; and
processing circuitry, wherein the processing circuitry is configured to:
identify a presence of a user proximate to the vehicle;
detect, based on the accelerometer signal, a gesture input; and
in response to detecting the gesture input, cause a vehicle action to be performed.

11. The vehicle of claim 10, wherein the gesture input comprises two knocks within a period of time on a door of the vehicle.

12. The vehicle of claim 11, wherein the vehicle action comprises locking or unlocking the door.

13. The vehicle of claim 10, wherein the accelerometer is located on or within a door handle of the vehicle.

14. The vehicle of claim 10, wherein:
the gesture input is one of a plurality of different detectable gesture inputs; and
each one of the plurality of different detectable gesture inputs corresponds to a vehicle action.

15. The vehicle of claim 10, further comprising:
a transceiver configured to receive a short-range wireless signal of a user device,
wherein the processing circuitry is configured to identify the presence of the user based on a received short-range wireless signal.

16. The vehicle of claim 10, wherein the processing circuitry is further configured to:
in response to detecting the gesture input and not identifying the presence of the user proximate to the vehicle, cause an alarm of the vehicle to be triggered.

17. The vehicle of claim 10, wherein the vehicle action comprises locking or unlocking a single door, locking or unlocking all of the doors, opening or closing windows, opening or closing vehicle enclosures, activating or deactivating a guard mode, activating or deactivating alarm monitoring, or triggering an alarm, or a combination thereof.

18. The vehicle of claim 10, wherein the processing circuitry is further configured to:
filter, using a noise filter the accelerometer signal to attenuate noise from vehicle movement.

19. A non-transitory computer-readable medium having non-transitory computer-readable instructions encoded thereon that, when executed by a processor, causes the processor to:
identify a presence of a user proximate to a vehicle;
detect a gesture input based on an accelerometer signal; and
in response to detecting the gesture input, performing a vehicle action.

20. The non-transitory computer-readable medium of claim 19, wherein:
the gesture input comprises two knocks within a period of time on a door of the vehicle; and
the vehicle action comprises locking or unlocking the door.
